(19) United States
(12) Patent Application Publication
(10) Pub. No.: US 2024/0104865 A1
(43) Pub. Date: Mar. 28, 2024

(54) FEATURE EXTRACTION USING A POINT OF A COLLECTION OF POINTS

(71) Applicant: FARO Technologies, Inc., Lake Mary, FL (US)

(72) Inventors: Samuel Moura, Vila Nova de Gaia (PT); Jaime Duarte Rodrigues, Porto (PT); Raphael Espanha, Braga (PT); Hooshiar Zolfagharnasab, Porto (PT)

(21) Appl. No.: 18/447,019

(22) Filed: Aug. 9, 2023

Related U.S. Application Data
(60) Provisional application No. 63/409,046, filed on Sep. 22, 2022.

(51) Int. Cl. G06T 19/00; G06T 7/13; G06V 10/44; G06V 10/77; G06V 10/774

(52) U.S. Cl. CPC G06T 19/006; G06T 7/13; G06V 10/44; G06V 10/7715; G06V 10/774; G06T 2207/10028; G06T 2207/20081; G06T 2207/20084; G06T 2210/56

(57) ABSTRACT

An example method for feature extraction includes receiving a selection of a point from a plurality of points, the plurality of points representing an object. The method further includes identifying a feature of interest for the object based at least in part on the point. The method further includes performing edge extraction on the feature of interest. The method further includes performing pre-processing on results of the edge extraction. The method further includes classifying the feature of interest based at least in part on results of the pre-processing. The method further includes constructing, based at least in part on results of the classifying, a geometric primitive or mathematical function that has a best fit to a set of points from the plurality of points associated with the feature of interest. The method further includes generating a graphical representation of the feature of interest using the geometric primitive or mathematical function.

### CROSS-REFERENCE TO RELATED APPLICATIONS

This application claims the benefit of U.S. Provisional Patent Application Ser. No. 63/409,046, filed Sep. 22, 2022, and entitled “FEATURE EXTRACTION USING A POINT OF A COLLECTION OF POINTS,” the contents of which are incorporated by reference herein in their entirety.

### BACKGROUND

The subject matter disclosed herein relates to use of a three-dimensional (3D) laser scanner time-of-flight (TOF) coordinate measurement device. A coordinate measurement device of this type steers a beam of light to a non-cooperative target such as a diffusely scattering surface of an object. A distance meter in the device measures a distance to the object, and angular encoders measure the angles of rotation of two axles in the device. The measured distance and two angles enable a processor in the device to determine the 3D coordinates of the target.

A laser scanner TOF coordinate measurement device (or simply “laser scanner”) is a scanner in which the distance to a target point is determined based on the speed of light in air between the scanner and a target point. Laser scanners are typically used for scanning closed or open spaces such as interior areas of buildings, industrial installations and tunnels. They may also be used, for example, in industrial applications and accident reconstruction applications. A laser scanner optically scans and measures objects in a volume around the scanner through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected, stored and sent to a processor or processors to generate a 3D image representing the scanned area or object.

Generating an image requires at least three values for each data point. These three values may include the distance and two angles, or may be transformed values, such as the x, y, z coordinates. In an embodiment, an image is also based on a fourth gray-scale value, which is a value related to irradiance of scattered light returning to the scanner.

Most laser scanner TOF coordinate measurement devices direct the beam of light within the measurement volume by steering the light with a beam steering mechanism. The beam steering mechanism includes a first motor that steers the beam of light about a first axis by a first angle that is measured by a first angular encoder (or another angle transducer). The beam steering mechanism also includes a second motor that steers the beam of light about a second axis by a second angle that is measured by a second angular encoder (or another angle transducer).

Many contemporary laser scanners include a camera mounted on the laser scanner for gathering camera digital images of the environment and for presenting the camera digital images to an operator of the laser scanner. By viewing the camera images, the operator of the scanner can determine the field of view of the measured volume and adjust settings on the laser scanner to measure over a larger or smaller region of space. In addition, the camera digital images may be transmitted to a processor to add color to the scanner image. To generate a color scanner image, at least three positional coordinates (such as x, y, z) and three color values (such as red, green, blue “RGB”) are collected for each data point.

One application where coordinate measurement devices such as laser scanners are used is to scan an object. Another application where coordinate measurement devices such as laser scanners are used in to scan an environment.

Accordingly, while existing coordinate measurement devices are suitable for their intended purposes, what is needed is a coordinate measurement device having certain features of embodiments of the present invention.

### BRIEF DESCRIPTION

In one exemplary embodiment, a method for feature extraction is provided. The method includes receiving a selection of a point from a plurality of points, the plurality of points representing an object. The method further includes identifying a feature of interest for the object based at least in part on the point. The method further includes performing edge extraction on the feature of interest. The method further includes performing pre-processing on results of the edge extraction. The method further includes classifying the feature of interest based at least in part on results of the pre-processing. The method further includes constructing, based at least in part on results of the classifying, a geometric primitive or mathematical function that has a best fit to a set of points from the plurality of points associated with the feature of interest. The method further includes generating a graphical representation of the feature of interest using the geometric primitive or mathematical function.

In addition to one or more of the features described herein, or as an alternative, further embodiments of the method may include that the plurality of points form a point cloud, wherein the point cloud is based on data captured by a three-dimensional (3D) coordinate measurement device.

In addition to one or more of the features described herein, or as an alternative, further embodiments of the method may include that the 3D coordinate measurement device is a laser scanner.

In addition to one or more of the features described herein, or as an alternative, further embodiments of the method may include that performing the edge extraction is performed using tensor voting.

In addition to one or more of the features described herein, or as an alternative, further embodiments of the method may include that performing the edge extraction includes: determining a normal of points from the plurality of points associated with the feature of interest; constructing a matrix using the normal; calculating eigen values for the matrix; identifying sharp edge vertices based on the eigen values; and clustering the sharp edge vertices.

In addition to one or more of the features described herein, or as an alternative, further embodiments of the method may include that performing the pre-processing includes performing at least one pre-process selected from a group consisting of performing noise reduction on the results of the edge extraction, performing up-sampling on relative less dense areas of the results of the edge extraction, and performing filtering to remove outliers from the results of the edge extraction.

In addition to one or more of the features described herein, or as an alternative, further embodiments of the method may include that the classifying is performed using a machine learning model.

In addition to one or more of the features described herein, or as an alternative, further embodiments of the method may include training the machine learning model.

In addition to one or more of the features described herein, or as an alternative, further embodiments of the method may include that training the machine learning model includes: generating a two-dimensional (2D) mask of primitives; applying a 2D data augmentation to the 2D mask of primitives to generate augmented images; and for each augmented image: identifying contours and applying a point-level transformation, and adding depth information based on the contours and the point-level transformation.

In another exemplary embodiment, a system for feature extraction is provided. The system includes a three-dimensional (3D) coordinate measurement device to collect a plurality of points representing an object. The system further includes a processing system that includes a memory having computer readable instructions and a processing device for executing the computer readable instructions. The computer readable instructions control the processing device to perform operations. The operations include receiving a selection of a point from the plurality of points. The operations further include identifying a feature of interest for the object based at least in part on the point. The operations further include performing edge extraction on the feature of interest. The operations further include classifying the feature of interest based at least in part on results of the edge extraction.

In addition to one or more of the features described herein, or as an alternative, further embodiments of the system may include that the plurality of points form a point cloud.

In addition to one or more of the features described herein, or as an alternative, further embodiments of the system may include that the 3D coordinate measurement device is a laser scanner.

In addition to one or more of the features described herein, or as an alternative, further embodiments of the system may include that performing the edge extraction is performed using tensor voting.

In addition to one or more of the features described herein, or as an alternative, further embodiments of the system may include that performing the edge extraction includes: determining a normal of points from the plurality of points associated with the feature of interest; constructing a matrix using the normal; calculating eigen values for the matrix; identifying sharp edge vertices based on the eigen values; and clustering the sharp edge vertices.

In addition to one or more of the features described herein, or as an alternative, further embodiments of the system may include that the operations further include performing pre-processing on results of the edge extraction.

In addition to one or more of the features described herein, or as an alternative, further embodiments of the system may include that performing the pre-processing includes performing at least one pre-process selected from a group consisting of performing noise reduction on the results of the edge extraction, performing up-sampling on relative less dense areas of the results of the edge extraction, and performing filtering to remove outliers from the results of the edge extraction.

In addition to one or more of the features described herein, or as an alternative, further embodiments of the system may include that the classifying is performed using a machine learning model.

In addition to one or more of the features described herein, or as an alternative, further embodiments of the system may include that the operations further include training the machine learning model.

In addition to one or more of the features described herein, or as an alternative, further embodiments of the system may include that the operations further comprise extracting, based at least in part on results of the classifying, a set of points from the plurality of points associated with the feature of interest.

In addition to one or more of the features described herein, or as an alternative, further embodiments of the system may include that the operations further include generating a graphical representation of the feature of interest based at least in part on classifying the feature of interest.

In addition to one or more of the features described herein, or as an alternative, further embodiments of the system may include that the 3D coordinate measurement device is a laser scanner.

In another exemplary embodiment, a method for training a machine learning model to classify a feature of interest of an object is provided. The method includes receiving original point cloud training data. The method further includes generating synthetic point cloud training data. The method further includes training the machine learning model using the original point cloud data and the synthetic point cloud training data, the machine learning model generating an output indicating a class of the feature of interest of the object.

In addition to one or more of the features described herein, or as an alternative, further embodiments of the method may include that generating the synthetic point cloud training data includes generating a two-dimensional (2D) mask of primitives.

In addition to one or more of the features described herein, or as an alternative, further embodiments of the method may include that generating the synthetic point cloud training data includes applying a 2D data augmentation to the 2D mask of primitives to generate augmented images.

In addition to one or more of the features described herein, or as an alternative, further embodiments of the method may include that generating the synthetic point cloud training data includes, for each augmented image, identifying contours and applying a point-level transformation.

In addition to one or more of the features described herein, or as an alternative, further embodiments of the method may include that the point-level transformation is a randomly selected transformation selected from a group consisting of a dropout transformation and a noise transformation.

In addition to one or more of the features described herein, or as an alternative, further embodiments of the method may include that generating the synthetic point cloud training data comprises, for each transformed point set, adding depth information based on a real-world sample analysis.

In addition to one or more of the features described herein, or as an alternative, further embodiments of the method may include that applying the 2D data augmentation includes applying a distortion to the 2D mask of primitives to generate the augmented images.

In addition to one or more of the features described herein, or as an alternative, further embodiments of the method may include that applying the 2D data augmentation includes applying a scaling to the 2D mask of primitives to generate the augmented images.

In addition to one or more of the features described herein, or as an alternative, further embodiments of the method may include that applying the 2D data augmentation includes applying a rotation to the 2D mask of primitives to generate the augmented images.

In addition to one or more of the features described herein, or as an alternative, further embodiments of the method may include performing inference on real-world point cloud data to identify, using the point cloud data, a real-world feature of interest for a real-world object.

In addition to one or more of the features described herein, or as an alternative, further embodiments of the method may include that the original point cloud training data is collected by a three-dimensional coordinate measurement device.

In addition to one or more of the features described herein, or as an alternative, further embodiments of the method may include that the original point cloud training data represents a real-world feature of interest of a real-world object.

In another exemplary embodiment, a system for training a machine learning model to classify a feature of interest of an object is provided. The system includes a three-dimensional (3D) coordinate measurement device to collect original point cloud training data and a processing system. The processing system includes a memory having computer readable instructions and a processing device for executing the computer readable instructions. The computer readable instructions control the processing device to perform operations. The operations include generating synthetic point cloud training data. The operations further include training the machine learning model using the original point cloud data and the synthetic point cloud training data, the machine learning model generating an output indicating a class of the feature of interest of the object.

In addition to one or more of the features described herein, or as an alternative, further embodiments of the system may include that generating the synthetic point cloud training data includes: generating a two-dimensional (2D) mask of primitives; applying a 2D data augmentation to the 2D mask of primitives to generate augmented images; and for each augmented image: identifying contours and applying a point-level transformation, and adding depth information.

In addition to one or more of the features described herein, or as an alternative, further embodiments of the system may include that the point-level transformation is a randomly selected transformation selected from a group consisting of a dropout transformation and a noise transformation.

In addition to one or more of the features described herein, or as an alternative, further embodiments of the system may include that generating the synthetic point cloud training data includes, for each augmented image, adding depth information based on a real-world sample analysis.

In addition to one or more of the features described herein, or as an alternative, further embodiments of the system may include that applying the 2D data augmentation includes applying a distortion to the 2D mask of primitives to generate the augmented images.

In addition to one or more of the features described herein, or as an alternative, further embodiments of the system may include that applying the 2D data augmentation includes applying a scaling to the 2D mask of primitives to generate the augmented images.

In addition to one or more of the features described herein, or as an alternative, further embodiments of the system may include that applying the 2D data augmentation includes applying a rotation to the 2D mask of primitives to generate the augmented images.

In another exemplary embodiment, a method for training a machine learning model to classify a feature of interest is provided. The method includes receiving original point cloud training data. The method further includes generating synthetic point cloud training data by generating a two-dimensional (2D) mask of primitives, applying a 2D data augmentation to the 2D mask of primitives to generate augmented images, and for each augmented image, identifying contours and applying a point-level transformation and adding depth information based on real-world sample analysis. The method further includes training the machine learning model using the original point cloud data and the synthetic point cloud training data, the machine learning model generating an output indicating a most probable class of the feature of interest.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of a laser scanner according to one or more embodiments described herein;

FIG. 2 is a side view of the laser scanner illustrating a method of measurement according to one or more embodiments described herein;

FIG. 3 is a schematic illustration of the optical, mechanical, and electrical components of the laser scanner according to one or more embodiments described herein;

FIG. 4 is a schematic illustration of the laser scanner of FIG. 1 according to one or more embodiments described herein;

FIG. 5 is a schematic illustration of a processing system for feature extraction using a single point of a collection of points according to one or more embodiments described herein;

FIG. 6 is a flow diagram of a method for performing feature extraction using a point of a collection of points according to one or more embodiments described herein;

FIG. 7A is a representation of a point selection according to one or more embodiments described herein;

FIG. 7B is a representation of edge extraction according to one or more embodiments described herein;

FIG. 7C is a representation of pre-processing according to one or more embodiments described herein;

FIG. 7D is a representation of classification according to one or more embodiments described herein;

FIG. 7E is a representation of extraction according to one or more embodiments described herein;

FIG. 8 is a block diagram of components of a machine learning training and inference system according to one or more embodiments described herein;

FIG. 9A is a flow diagram of a method for training a machine learning model that can be used for classifying features of interest according to one or more embodiments described herein;

FIG. 9B is a flow diagram of a method for generating synthetic point cloud training data according to one or more embodiments described herein;

FIGS. 10A-10G depict aspects of generating synthetic point cloud training data according to one or more embodiments described herein;

FIGS. 11A-11D depict example synthetic point cloud training data according to one or more embodiments described herein; and

FIG. 12 is a schematic illustration of a processing system for implementing the presently described techniques according to one or more embodiments described herein.

The detailed description explains embodiments of the disclosure, together with advantages and features, by way of example with reference to the drawings.

### DETAILED DESCRIPTION

One or more embodiments described herein relate to feature extraction. Feature extraction involves the identification of a feature of interest of an object and the extraction of a subset of points, from a larger set of points, that are associated with the feature of interest. Feature extraction is useful for inspecting an object, such as to verify whether the object conforms with a reference (e.g., a ground truth), which may be defined by a computer aided design (CAD) model, building information modeling (BIM) model, and/or the like, including combinations and/or multiples thereof.

Conventional feature extraction involves a user selecting points in which the desired feature is included and then the user selecting which feature is going to be extracted so a correct solver can be used. These two steps are user-supervised steps meaning that the user first performs a selection (e.g., segmentation) of points, such as from a point cloud, for a feature of interest of an object because the user knows which points to select. Next, the user classifies the feature of interest by inputting or selecting a shape type (e.g., class) so a correct fitting algorithm can be initialized and executed on the points from the selection.

As an example of conventional feature extraction, a display presents three-dimensional (3D) data, such as a point cloud, of an object to a user. The 3D data can be collected using a 3D coordinate measurement device, such as a laser scanner, as described herein. The user then chooses a selection tool (e.g., rectangular selection tool, lasso selection tool, polygon selection tool, and/or the like, including combinations and/or multiples thereof) and uses the selection tool to define a region of the 3D data (e.g., point cloud) that includes the feature of interest. The user then classifies the feature of interest by inputting on selecting a shape type (e.g., plane, line, circle, sphere, cylinder, cone, torus, round slot, rectangular slot, ellipse, and/or the like). A suitable feature solver then processes the data contained within the defined region using the shape type to identify the feature of interest and extract points associated with the feature of interest. This process is largely manual and requires accurate selections by the user at each stage. However, if either selection is incorrect, conventional feature extraction fails. For example, if the user defines an incorrect region or selects an incorrect shape type, the feature extraction may extract the wrong points or may not function at all.

One or more embodiments described herein addresses these and other shortcomings of conventional feature extraction. According to one or more embodiments described herein, a user selects a point (e.g., a single point) near a feature of interest. Using this point, one or more embodiments described herein performs edge extraction on the feature of interest, performs pre-processing (e.g., denoising, filtering, and/or the like, including combinations and/or multiples thereof) on results of the edge extraction, and classifies the feature of interest based on result of the pre-processing. According to one or more embodiments described herein, the classification can be performed using artificial intelligence (AI), such as machine learning (ML). This eliminates potential incorrect classification by a user and reduces demands on the user.

One or more embodiments described herein provide one or more advantages over the prior art. For example, one or more embodiments described herein provide for identifying features of interest in point cloud data based on a single point selection where the feature of interest is automatically identified and classified based on the selected point. This process provides more accurate and precise feature identification when processing point cloud data. Further, one or more embodiments described herein provide for generating synthetic point cloud data used to train a machine learning model to classify features of interest. Generating synthetic point cloud data improves training a machine learning model to perform classification where insufficient original training data is available. Further, generating the synthetic point cloud data reduces the amount of resources (e.g., memory, processing load, etc.) associated with collecting (e.g., by performing a scan using the scanner 520) original training data. Increased training data improves the resulting trained machine learning model to achieve better generalization capability (e.g., perform better on unseen data). Further, synthetic data provides for training more accurate and efficient machine learning models because the synthetic training data can be created using techniques that manipulate the data (e.g., transformations) that provide additional views that may not be available in original training data. According to an example, transformations used to create the synthetic training data can be tunned based on real world sample statistics (e.g., amount of depth points, amount of noise, and/or the like, including combinations and/or multiples thereof).

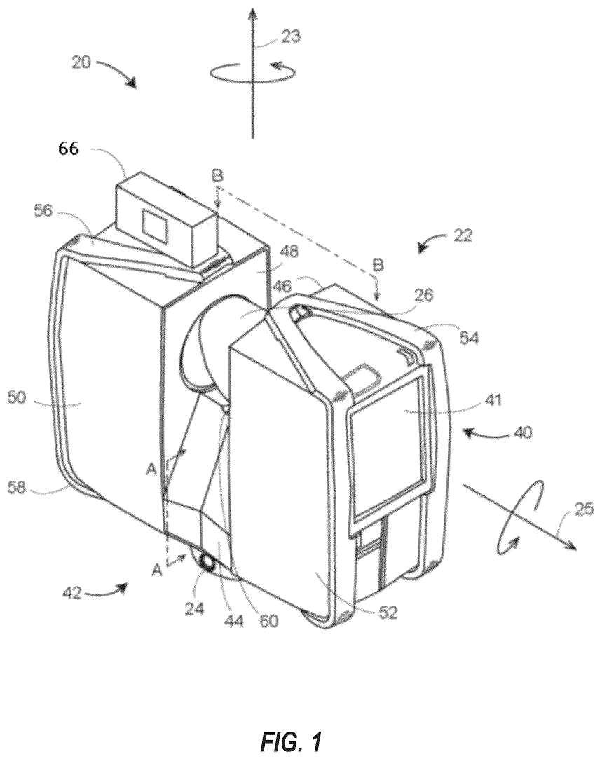

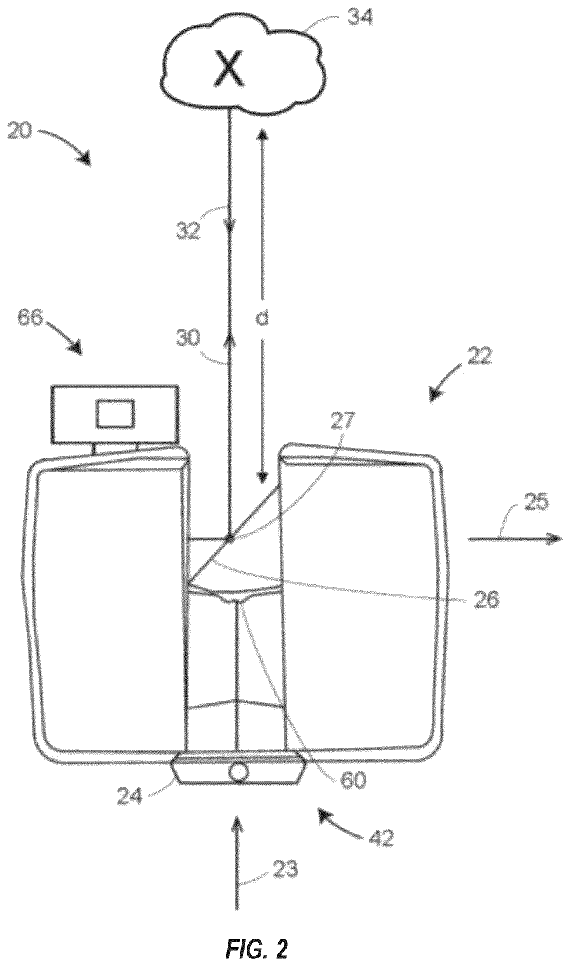

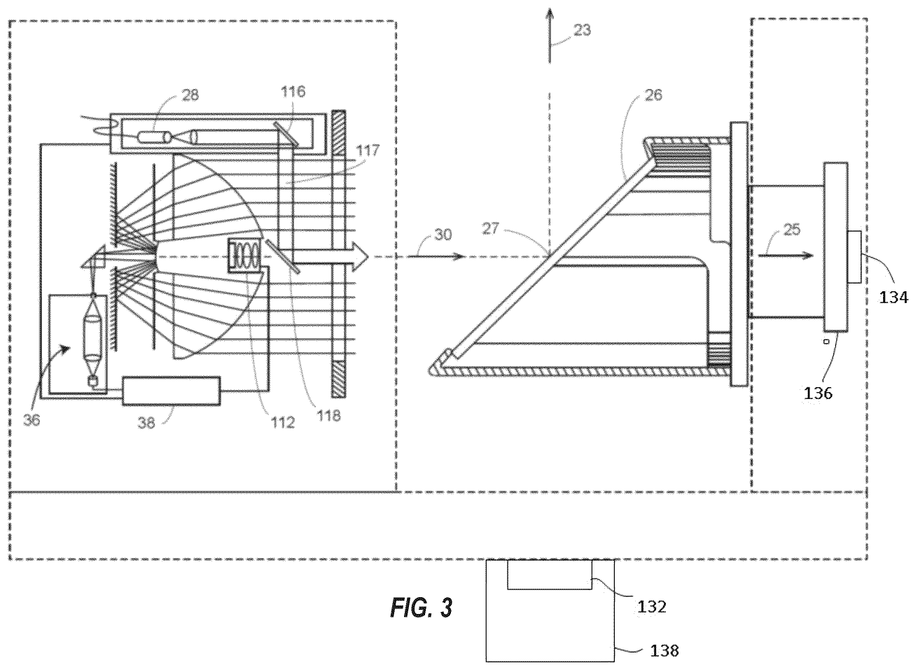

Referring now to FIGS. 1-3, a 3D coordinate measurement device, such as a laser scanner 20, is shown for optically scanning and measuring the environment surrounding the laser scanner 20 according to one or more embodiments described herein. The laser scanner 20 has a measuring head 22 and a base 24. The measuring head 22 is mounted on the base 24 such that the laser scanner 20 may be rotated about a vertical axis 23. In one embodiment, the measuring head 22 includes a gimbal point 27 that is a center of rotation about the vertical axis 23 and a horizontal axis 25. The measuring head 22 has a rotary mirror 26, which may be rotated about the horizontal axis 25. The rotation about the vertical axis may be about the center of the base 24. The terms vertical axis and horizontal axis refer to the scanner in its normal upright position. It is possible to operate a 3D coordinate measurement device on its side or upside down, and so to avoid confusion, the terms azimuth axis and zenith axis may be substituted for the terms vertical axis and horizontal axis, respectively. The term pan axis or standing axis may also be used as an alternative to vertical axis.

The measuring head 22 is further provided with an electromagnetic radiation emitter, such as light emitter 28, for example, that emits an emitted light beam 30. In one embodiment, the emitted light beam 30 is a coherent light beam such as a laser beam. The laser beam may have a wavelength range of approximately 300 to 1600 nanometers, for example 790 nanometers, 905 nanometers, 1550 nm, or less than 400 nanometers. It should be appreciated that other electromagnetic radiation beams having greater or smaller wavelengths may also be used. The emitted light beam 30 is amplitude or intensity modulated, for example, with a sinusoidal waveform or with a rectangular waveform. The emitted light beam 30 is emitted by the light emitter 28 onto a beam steering unit, such as mirror 26, where it is deflected to the environment. A reflected light beam 32 is reflected from the environment by an object 34. The reflected or scattered light is intercepted by the rotary mirror 26 and directed into a light receiver 36. The directions of the emitted light beam 30 and the reflected light beam 32 result from the angular positions of the rotary mirror 26 and the measuring head 22 about the axes 25 and 23, respectively. These angular positions in turn depend on the corresponding rotary drives or motors.

Coupled to the light emitter 28 and the light receiver 36 is a controller 38. The controller 38 determines, for a multitude of measuring points X, a corresponding number of distances d between the laser scanner 20 and the points X on object 34. The distance to a particular point X is determined based at least in part on the speed of light in air through which electromagnetic radiation propagates from the device to the object point X. In one embodiment the phase shift of modulation in light emitted by the laser scanner 20 and the point X is determined and evaluated to obtain a measured distance d.

The speed of light in air depends on the properties of the air such as the air temperature, barometric pressure, relative humidity, and concentration of carbon dioxide. Such air properties influence the index of refraction n of the air. The speed of light in air is equal to the speed of light in vacuum c divided by the index of refraction. In other words, cₐᵢᵣ=c/n. A laser scanner of the type discussed herein is based on the time-of-flight (TOF) of the light in the air (the round-trip time for the light to travel from the device to the object and back to the device). Examples of TOF scanners include scanners that measure round trip time using the time interval between emitted and returning pulses (pulsed TOF scanners), scanners that modulate light sinusoidally and measure phase shift of the returning light (phase-based scanners), as well as many other types. A method of measuring distance based on the time-of-flight of light depends on the speed of light in air and is therefore easily distinguished from methods of measuring distance based on triangulation. Triangulation-based methods involve projecting light from a light source along a particular direction and then intercepting the light on a camera pixel along a particular direction. By knowing the distance between the camera and the projector and by matching a projected angle with a received angle, the method of triangulation enables the distance to the object to be determined based on one known length and two known angles of a triangle. The method of triangulation, therefore, does not directly depend on the speed of light in air.

In one mode of operation, the scanning of the volume around the laser scanner 20 takes place by rotating the rotary mirror 26 relatively quickly about axis 25 while rotating the measuring head 22 relatively slowly about axis 23, thereby moving the assembly in a spiral pattern. In an exemplary embodiment, the rotary mirror rotates at a maximum speed of 5820 revolutions per minute. For such a scan, the gimbal point 27 defines the origin of the local stationary reference system. The base 24 rests in this local stationary reference system.

In addition to measuring a distance d from the gimbal point 27 to an object point X, the laser scanner 20 may also collect gray-scale information related to the received optical power (equivalent to the term “brightness.”) The gray-scale value may be determined at least in part, for example, by integration of the bandpass-filtered and amplified signal in the light receiver 36 over a measuring period attributed to the object point X.

The measuring head 22 may include a display device 40 integrated into the laser scanner 20. The display device 40 may include a graphical touch screen 41, as shown in FIG. 1, which allows the operator to set the parameters or initiate the operation of the laser scanner 20. For example, the screen 41 may have a user interface that allows the operator to provide measurement instructions to the device, and the screen may also display measurement results.

The laser scanner 20 includes a carrying structure 42 that provides a frame for the measuring head 22 and a platform for attaching the components of the laser scanner 20. In one embodiment, the carrying structure 42 is made from a metal such as aluminum. The carrying structure 42 includes a traverse member 44 having a pair of walls 46, 48 on opposing ends. The walls 46, 48 are parallel to each other and extend in a direction opposite the base 24. Shells 50, 52 are coupled to the walls 46, 48 and cover the components of the laser scanner 20. In the exemplary embodiment, the shells 50, 52 are made from a plastic material, such as polycarbonate or polyethylene for example. The shells 50, 52 cooperate with the walls 46, 48 to form a housing for the laser scanner 20.

On an end of the shells 50, 52 opposite the walls 46, 48 a pair of yokes 54, 56 are arranged to partially cover the respective shells 50, 52. In the exemplary embodiment, the yokes 54, 56 are made from a suitably durable material, such as aluminum for example, that assists in protecting the shells 50, 52 during transport and operation. The yokes 54, 56 each includes a first arm portion 58 that is coupled, such as with a fastener for example, to the traverse 44 adjacent the base 24. The arm portion 58 for each yoke 54, 56 extends from the traverse 44 obliquely to an outer corner of the respective shell 50, 52. From the outer corner of the shell, the yokes 54, 56 extend along the side edge of the shell to an opposite outer corner of the shell. Each yoke 54, 56 further includes a second arm portion that extends obliquely to the walls 46, 48. It should be appreciated that the yokes 54, 56 may be coupled to the traverse 42, the walls 46, 48 and the shells 50, 54 at multiple locations.

The pair of yokes 54, 56 cooperate to circumscribe a convex space within which the two shells 50, 52 are arranged. In the exemplary embodiment, the yokes 54, 56 cooperate to cover all of the outer edges of the shells 50, 54, while the top and bottom arm portions project over at least a portion of the top and bottom edges of the shells 50, 52. This provides advantages in protecting the shells 50, 52 and the measuring head 22 from damage during transportation and operation. In other embodiments, the yokes 54, 56 may include additional features, such as handles to facilitate the carrying of the laser scanner 20 or attachment points for accessories for example.

On top of the traverse 44, a prism 60 is provided. The prism extends parallel to the walls 46, 48. In the exemplary embodiment, the prism 60 is integrally formed as part of the carrying structure 42. In other embodiments, the prism 60 is a separate component that is coupled to the traverse 44. When the mirror 26 rotates, during each rotation the mirror 26 directs the emitted light beam 30 onto the traverse 44 and the prism 60. Due to non-linearities in the electronic components, for example in the light receiver 36, the measured distances d may depend on signal strength, which may be measured in optical power entering the scanner or optical power entering optical detectors within the light receiver 36, for example. In an embodiment, a distance correction is stored in the scanner as a function (possibly a nonlinear function) of distance to a measured point and optical power (generally unscaled quantity of light power sometimes referred to as “brightness”) returned from the measured point and sent to an optical detector in the light receiver 36. Since the prism 60 is at a known distance from the gimbal point 27, the measured optical power level of light reflected by the prism 60 may be used to correct distance measurements for other measured points, thereby allowing for compensation to correct for the effects of environmental variables such as temperature. In the exemplary embodiment, the resulting correction of distance is performed by the controller 38.

In an embodiment, the base 24 is coupled to a swivel assembly (not shown) such as that described in commonly owned U.S. Pat. No. 8,705,012 ('012), which is incorporated by reference herein. The swivel assembly is housed within the carrying structure 42 and includes a motor 138 that is configured to rotate the measuring head 22 about the axis 23. In an embodiment, the angular/rotational position of the measuring head 22 about the axis 23 is measured by angular encoder 134.

An auxiliary image acquisition device 66 may be a device that captures and measures a parameter associated with the scanned area or the scanned object and provides a signal representing the measured quantities over an image acquisition area. The auxiliary image acquisition device 66 may be, but is not limited to, a pyrometer, a thermal imager, an ionizing radiation detector, or a millimeter-wave detector. In an embodiment, the auxiliary image acquisition device 66 is a color camera.

In an embodiment, a central color camera (first image acquisition device) 112 is located internally to the scanner and may have the same optical axis as the 3D scanner device. In this embodiment, the first image acquisition device 112 is integrated into the measuring head 22 and arranged to acquire images along the same optical pathway as emitted light beam 30 and reflected light beam 32. In this embodiment, the light from the light emitter 28 reflects off a fixed mirror 116 and travels to dichroic beam-splitter 118 that reflects the light 117 from the light emitter 28 onto the rotary mirror 26. In an embodiment, the mirror 26 is rotated by a motor 136 and the angular/rotational position of the mirror is measured by angular encoder 134. The dichroic beam-splitter 118 allows light to pass through at wavelengths different than the wavelength of light 117. For example, the light emitter 28 may be a near infrared laser light (for example, light at wavelengths of 780 nm or 1250 nm), with the dichroic beam-splitter 118 configured to reflect the infrared laser light while allowing visible light (e.g., wavelengths of 400 to 700 nm) to transmit through. In other embodiments, the determination of whether the light passes through the beam-splitter 118 or is reflected depends on the polarization of the light. The digital camera 112 obtains 2D images of the scanned area to capture color data to add to the scanned image. In the case of a built-in color camera having an optical axis coincident with that of the 3D scanning device, the direction of the camera view may be easily obtained by simply adjusting the steering mechanisms of the scanner—for example, by adjusting the azimuth angle about the axis 23 and by steering the mirror 26 about the axis 25.

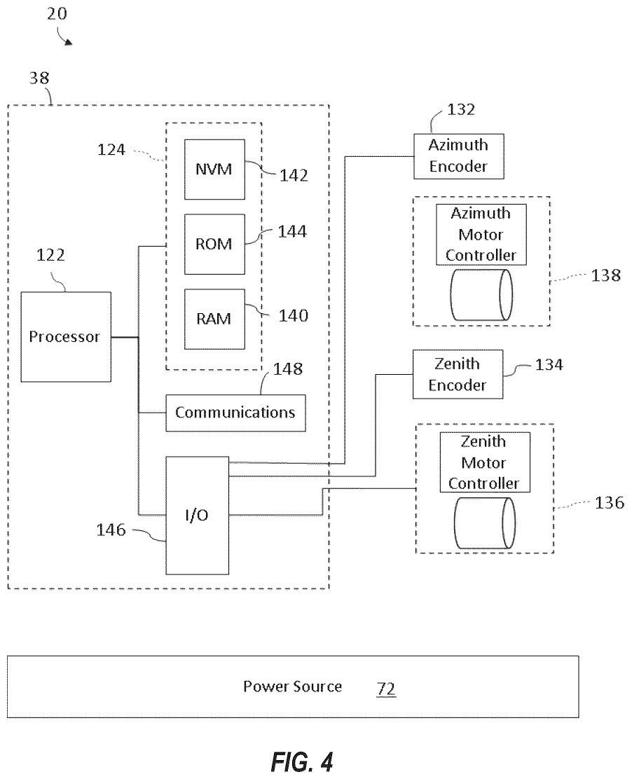

Referring now to FIG. 4 with continuing reference to FIGS. 1-3, elements are shown of the laser scanner 20. Controller 38 is a suitable electronic device capable of accepting data and instructions, executing the instructions to process the data, and presenting the results. The controller 38 includes one or more processing elements 122. The processors may be microprocessors, field programmable gate arrays (FPGAs), digital signal processors (DSPs), and generally any device capable of performing computing functions. The one or more processors 122 have access to memory 124 for storing information.

Controller 38 is capable of converting the analog voltage or current level provided by light receiver 36 into a digital signal to determine a distance from the laser scanner 20 to an object in the environment. Controller 38 uses the digital signals that act as input to various processes for controlling the laser scanner 20. The digital signals represent one or more laser scanner 20 data including but not limited to distance to an object, images of the environment, images acquired by panoramic camera 126, angular/rotational measurements by a first or azimuth encoder 132, and angular/rotational measurements by a second axis or zenith encoder 134.

In general, controller 38 accepts data from encoders 132, 134, light receiver 36, light source 28, and panoramic camera 126 and is given certain instructions for the purpose of generating a 3D point cloud of a scanned environment. Controller 38 provides operating signals to the light source 28, light receiver 36, panoramic camera 126, zenith motor 136 and azimuth motor 138. The controller 38 compares the operational parameters to predetermined variances and if the predetermined variance is exceeded, generates a signal that alerts an operator to a condition. The data received by the controller 38 may be displayed on a user interface 40 coupled to controller 38. The user interface 40 may be one or more LEDs (light-emitting diodes) 82, an LCD (liquid-crystal diode) display, a CRT (cathode ray tube) display, a touch-screen display or the like. A keypad may also be coupled to the user interface for providing data input to controller 38. In one embodiment, the user interface is arranged or executed on a mobile computing device that is coupled for communication, such as via a wired or wireless communications medium (e.g. Ethernet, serial, USB, Bluetooth™ or WiFi) for example, to the laser scanner 20.

The controller 38 may also be coupled to external computer networks such as a local area network (LAN) and the Internet. A LAN interconnects one or more remote computers, which are configured to communicate with controller 38 using a well-known computer communications protocol such as TCP/IP (Transmission Control Protocol/Internet(\hat{ }) Protocol), RS-232, ModBus, and the like. Additional systems 20 may also be connected to LAN with the controllers 38 in each of these systems 20 being configured to send and receive data to and from remote computers and other systems 20. The LAN may be connected to the Internet. This connection allows controller 38 to communicate with one or more remote computers connected to the Internet.

The processors 122 are coupled to memory 124. The memory 124 may include random access memory (RAM) device 140, a non-volatile memory (NVM) device 142, and a read-only memory (ROM) device 144. In addition, the processors 122 may be connected to one or more input/output (I/O) controllers 146 and a communications circuit 148. In an embodiment, the communications circuit 92 provides an interface that allows wireless or wired communication with one or more external devices or networks, such as the LAN discussed above.

Controller 38 includes operation control methods embodied in application code (e.g., program instructions executable by a processor to cause the processor to perform operations). These methods are embodied in computer instructions written to be executed by processors 122, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, C#, Objective-C, Visual C++, Java, ALGOL (algorithmic language), BASIC (beginners all-purpose symbolic instruction code), visual BASIC, ActiveX, HTML (HyperText Markup Language), Python, Ruby and any combination or derivative of at least one of the foregoing.

It should be appreciated that while embodiments herein describe the 3D coordinate measurement device as being a laser scanner, this is for example purposes and the claims should not be so limited. In other embodiments, the 3D coordinate measurement device may be another type of system that measures a plurality of points on surfaces (i.e., generates a point cloud), such as but not limited to a triangulation scanner, a structured light scanner, or a photogrammetry device for example.

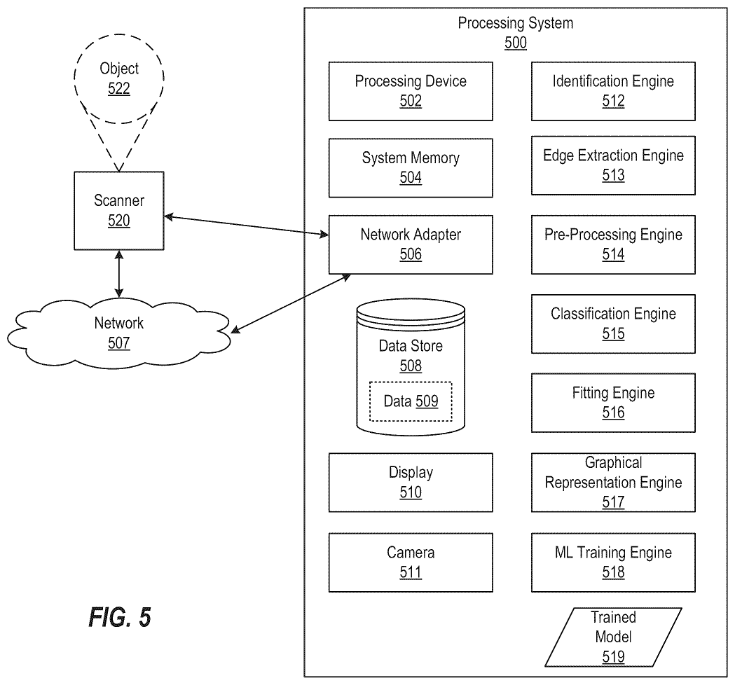

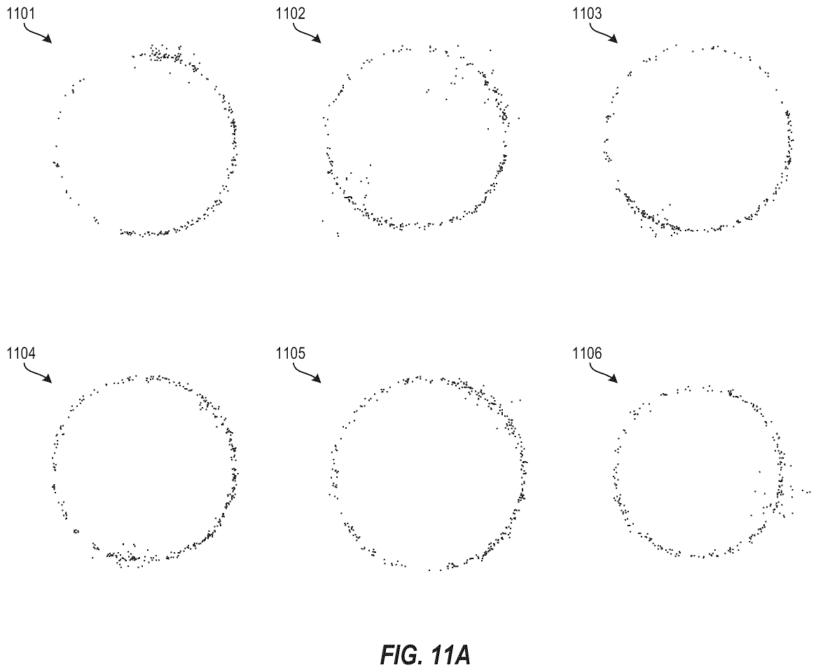

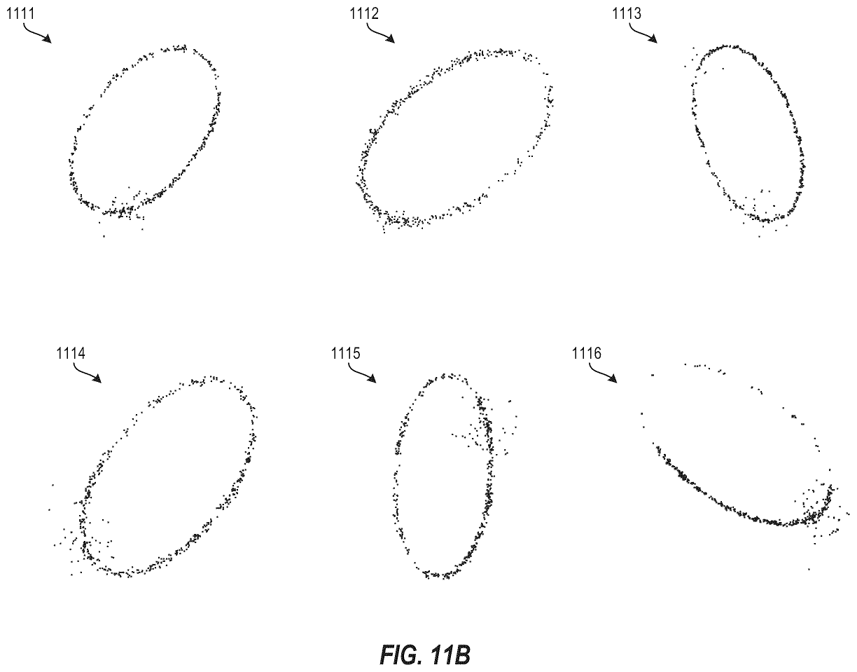

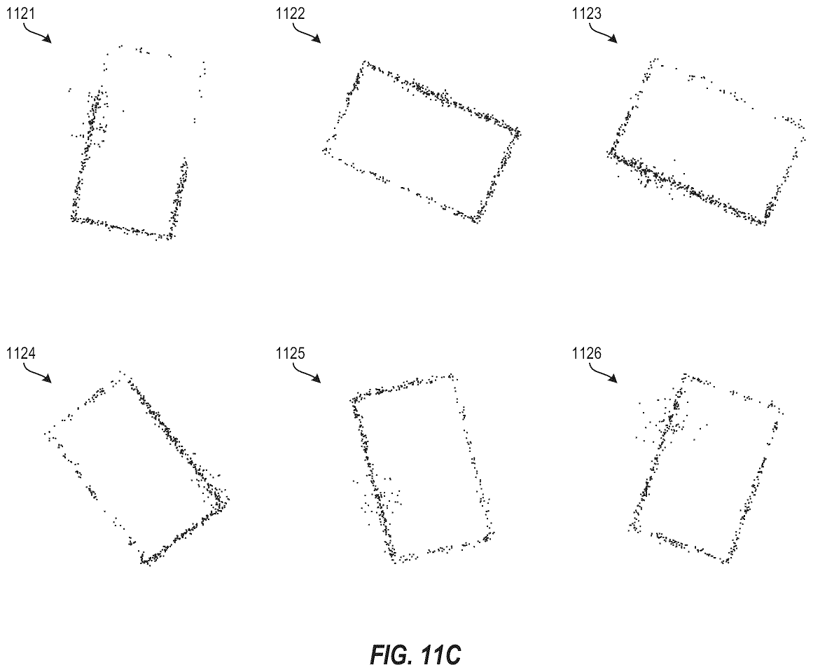

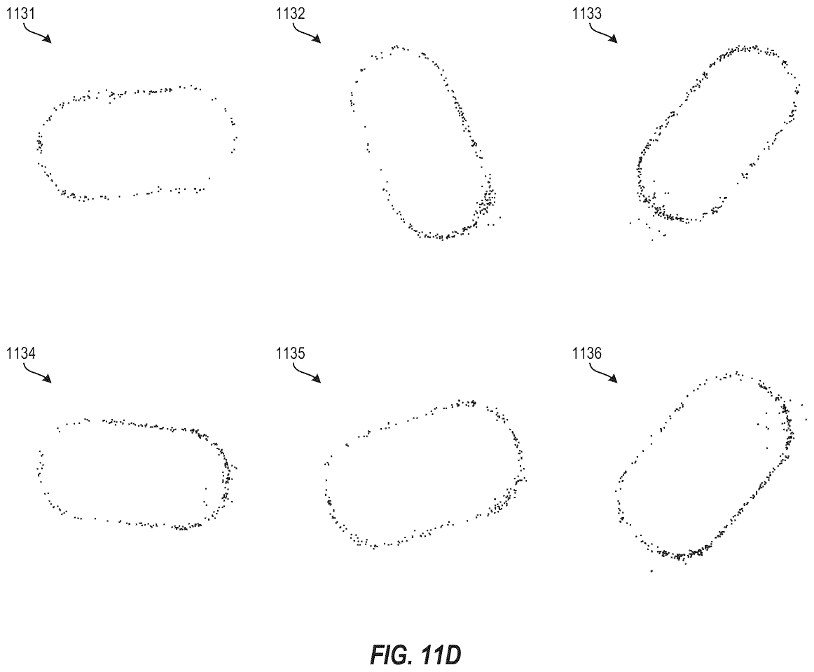

FIG. 5 is a schematic illustration of a processing system 500 for performing feature extraction according to one or more embodiments described herein. The processing system 500 includes a processing device 502 (e.g., one or more of the processing devices 1121 of FIG. 11), a system memory 504 (e.g., the RAM 1124 and/or the ROM 1122 of FIG. 11), a network adapter 506 (e.g., the network adapter 1126 of FIG. 11), a data store 508, a display 510, a camera 511, an identification engine 512, an edge extraction engine 513, a pre-processing engine 514, a classification engine 515, a fitting engine 516, a graphical representation engine 517, and a machine learning (ML) training engine 518.

The various components, modules, engines, etc. described regarding FIG. 5 (e.g., the identification engine 512, the edge extraction engine 513, the pre-processing engine 514, the classification engine 515, the fitting engine 516, the graphical representation engine 517, and the ML training engine 518) can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include the processing device 502 for executing those instructions. Thus, the system memory 504 can store program instructions that when executed by the processing device 502 implement the engines described herein. Other engines can also be utilized to include other features and functionality described in other examples herein.

The network adapter 506 enables the processing system 500 to transmit data to and/or receive data from other sources, such as the scanner 520. For example, the processing system 500 receives data (e.g., a data set that includes a plurality of three-dimensional coordinates of an object 522) from the scanner 520 directly and/or via a network 507. The data from the scanner 520 can be stored in the data store 508 of the processing system 500 as data 509, which can be used to display a point cloud or other graphical representation on the display 510. According to one or more embodiments described herein, the camera 511 can capture images of the object 522, which may be presented on the display 510 as a video stream of the object 522.

The network 507 represents any one or a combination of different types of suitable communications networks such as, for example, cable networks, public networks (e.g., the Internet), private networks, wireless networks, cellular networks, or any other suitable private and/or public networks. Further, the network 507 can have any suitable communication range associated therewith and may include, for example, global networks (e.g., the Internet), metropolitan area networks (MANs), wide area networks (WANs), local area networks (LANs), or personal area networks (PANs). In addition, the network 507 can include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

The scanner 520 (e.g., a laser scanner) can be arranged on, in, and/or around the object 522 to scan the object 522. It should be appreciated that while embodiments herein refer to a 3D coordinate measurement device as a laser scanner (e.g., the scanner 520), this is for example purposes and the claims should not be so limited. In other embodiments, other types of optical measurement devices may be used, such as but not limited to triangulation scanners and structured light scanners for example.

According to one or more embodiments described herein, the scanner 520 can include a scanner processing system including a scanner controller, a housing, and a three-dimensional (3D) scanner. The 3D scanner can be disposed within the housing and operably coupled to the scanner processing system. The 3D scanner includes a light source, a beam steering unit, a first angle measuring device, a second angle measuring device, and a light receiver. The beam steering unit cooperates with the light source and the light receiver to define a scan area. The light source and the light receiver are configured to cooperate with the scanner processing system to determine a first distance to a first object point based at least in part on a transmitting of a light by the light source and a receiving of a reflected light by the light receiver. The 3D scanner is further configured to cooperate with the scanner processing system to determine 3D coordinates of the first object point based at least in part on the first distance, a first angle of rotation, and a second angle of rotation.

The scanner 520 performs at least one scan to generate a data set that includes a plurality of three-dimensional coordinates of the object 522. The data set can be transmitted, directly or indirectly (such as via the network 507) to a processing system, such as the processing system 500, which can store the data set as the data 509 in the data store 508. It should be appreciated that other numbers of scanners (e.g., one scanner, three scanners, four scanners, six scanners, eight scanners, etc.) can be used. According to one or more embodiments described herein, one or more scanners can be used to take multiple scans. For example, the scanner 520 can capture first scan data of the object 522 at a first location and then be moved to a second location, where the scanner 520 captures second scan data of the object 522.

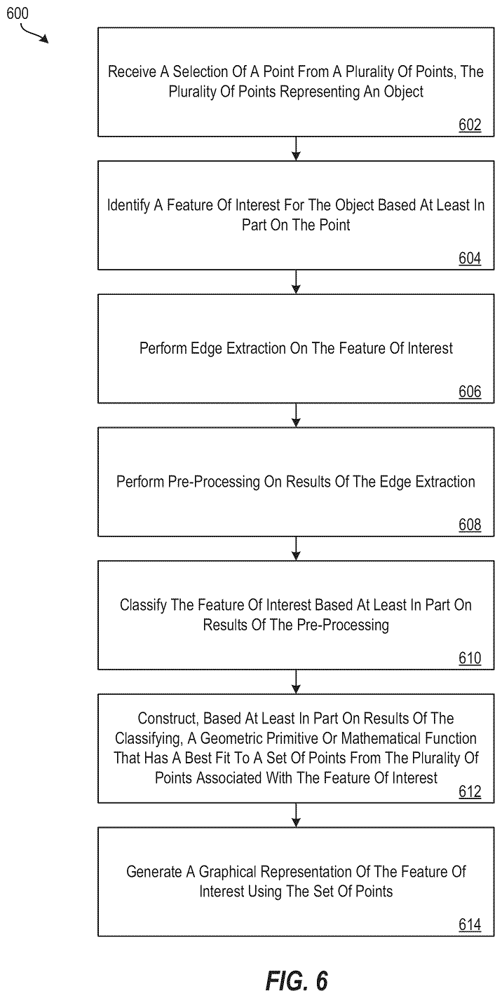

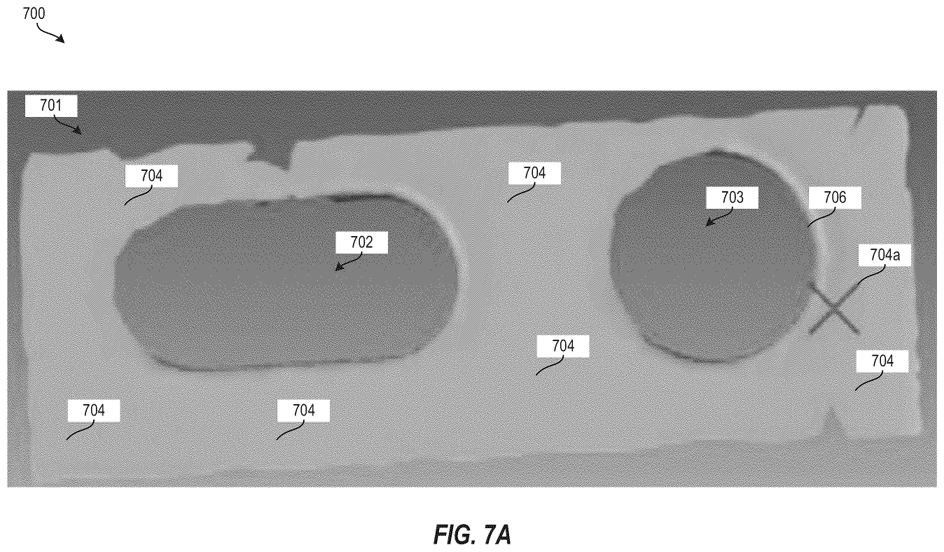

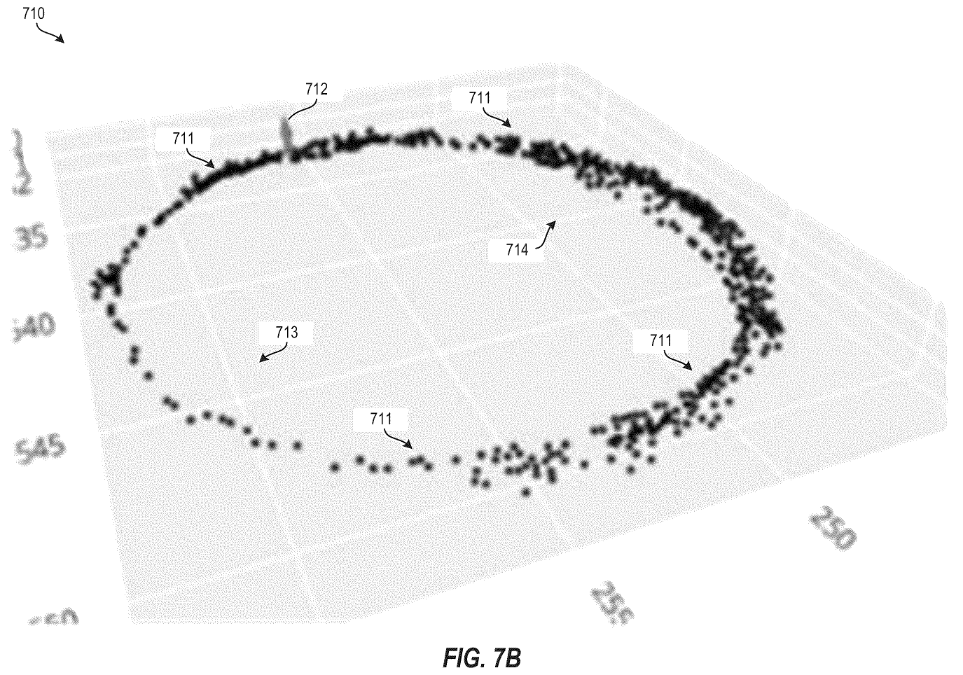

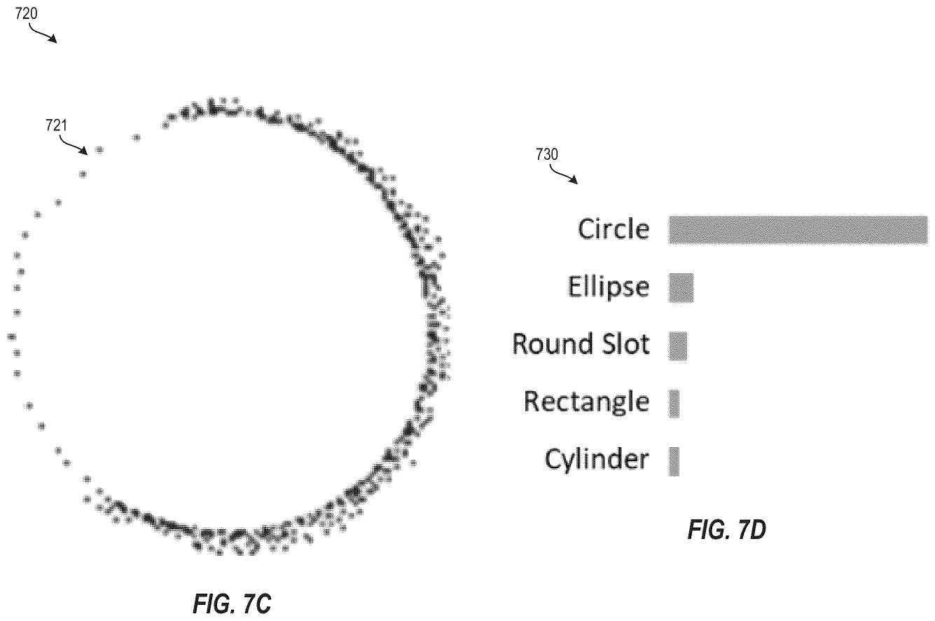

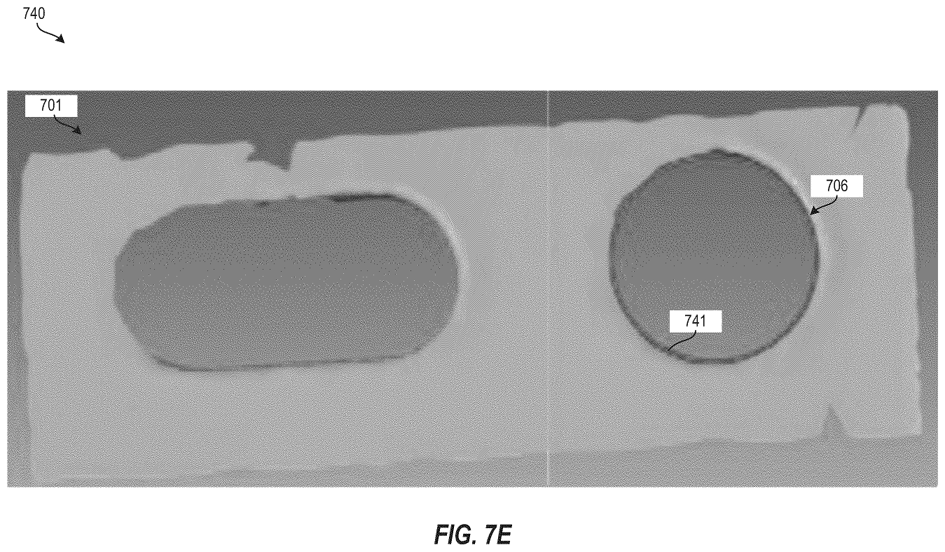

Using the data received from the scanner 520, the processing system 500 can perform feature extraction using the data 509 using one or more of the point the identification engine 512, the edge extraction engine 513, the pre-processing engine 514, the classification engine 515, the fitting engine 516, the graphical representation engine 517, and the ML training engine 518. For example, the identification engine 512 identifies a feature of interest for the object 522 based on a selected point from a plurality of points captured by the scanner 520. The edge extraction engine 513 performs edge extraction on the feature of interest, and the pre-processing engine 514 performs pre-processing (e.g., denoising, filtering, and/or the like, including combinations and/or multiples thereof) on results of the edge extraction. The classification engine 515 classifies the object 522 based on results of the pre-processing. The classification engine 515 can implement artificial intelligence, such as machine learning, by implementing a trained machine learning model to perform the classification. The trained machine learning model can be trained by the ML training engine 518. The fitting engine 516 acts as a solver that performs a process of constructing a geometric primitive, or mathematical function, that has the best fit to a series of data points. The output of the solver (e.g., the fitting engine 516) is the geometric primitive or mathematical function that is then used to create the graphical representation. The graphical representation engine 517 generates a graphical representation of the feature of interest. The features and functions of the engines 512-518 are now described in more detail with reference to FIGS. 6 and 7A-7E as examples.

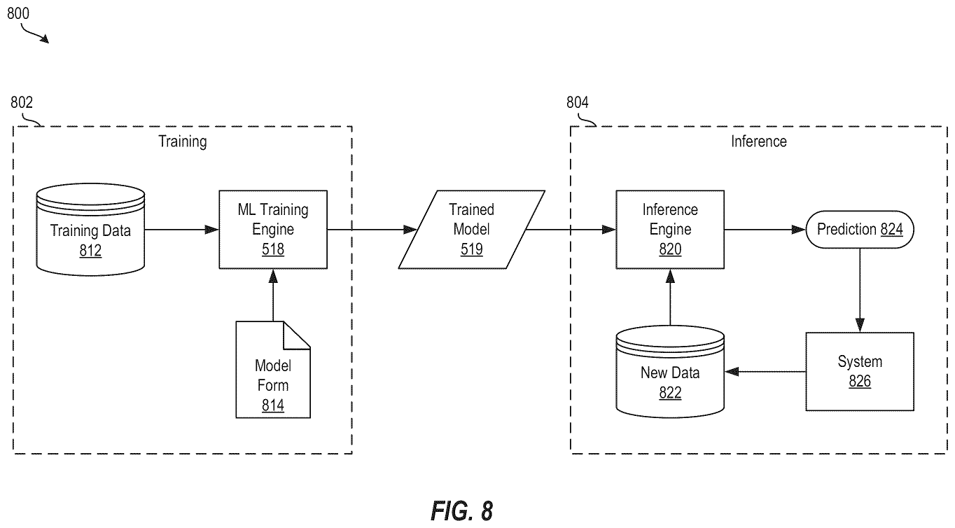

Turning now to FIG. 6, a flow diagram of a method 600 for feature extraction using a point of a collection of points according to one or more embodiments described herein. The method 600 can be performed by any suitable system or device, such as the processing system 500 of FIG. 5, the machine learning training and inference system 800 of FIG. 8, and/or the processing system 1100 of FIG. 11. The method 600 is now described with further reference to FIGS. 5 and 7A-7E.

Turning now to FIG. 6, at block 602, a processing system (e.g., the processing system 500) receives, such as from a user of the processing system, a selection of a point from a plurality of points. The plurality of points represents an object (e.g., the object 522). For example, FIG. 7A is a representation 700 that represents an object 701, which can be any suitable object, portion of an object, and/or the like, including combinations and/or multiples thereof. In this example, the object 701 includes two features 702, 703 (e.g., openings) shown in the representation 700. The object 701 is scanned, such as by a 3D coordinate measurement device (e.g., the scanner 520), to capture points 704 (e.g., 3D coordinates) that represent the object 701 and form the representation 700. Each of the points can be represented by three-dimensional coordinates (e.g., “x,y,z”). The user can select a point 704a from the points 704.

With continued reference to FIG. 6, at block 604, the processing system identifies (e.g., using the identification engine 512) a feature of interest for the object based at least in part on the point. That is, the point is used to identify a feature of interest. With reference to FIG. 7A, the feature of interest can be the feature 703, which is defined by an edge 706. In this example, the feature of interest is the feature 703 as opposed to the feature 702 due to the proximity of the point 704a selected by the user relative to the feature 703. That is, the point 704a is closer to the feature 703 than the point 704a is to the feature 702. Thus, the feature 703 is considered to be the feature of interest.

With continued reference to FIG. 6, at block 606, the processing system performs (e.g., using the edge extraction engine 513) edge extraction on the feature of interest. Edge extraction extracts points associated with the feature of interest. For example, in FIG. 7A, a subset of the points represents the feature of interest (e.g., the feature 703). In FIG. 7B, a representation 710 shows the subset of the points that represent the feature of interest as points 711.

According to one or more embodiments described herein, the edge extraction at block 606 is performed using tensor voting. Tensor voting involves the perceptional grouping or organization of points to extract features. As described herein, each of the points can be represented by three-dimensional coordinates. Additionally, or alternatively, in an embodiment, each of the points can be represented by a tensor, which is a container that stores data in “n” dimensions. One example of tensor voting is described in the publication entitled “Tensor Voting” by Gerard Medioni, which is incorporated by reference in its entirety. In tensor voting, each point communicates its information (in the form of a tensor) to its neighborhood through a tensor field and casts a tensor vote. The votes are collected at each point for votes cast at that point and a new tensor is generated. A matching process can be performed to detect features. By using tensor voting, the processing system identifies the subset of the points that represent the feature of interest (e.g., the points 711 of FIG. 7B)

According to one or more embodiments described herein, edge extraction at block 606 is determined by performing a spectral analysis which includes determining the “normal” of the points (for example, shown by the vector 712 of FIG. 7B) from the feature of interest and constructing a matrix using the normal of the points. Then, the eigen values for the matrix are calculated, and sharp edge vertices are identified. The sharp edge vertices can be identified by calculating the vertices considered to be sharp edges (e.g., defined thresholds for each matrix based on curvature (eigen values)), and the sharp edge vertices are then clustered, resulting in extracted points that represent the edge (e.g., the points 711 of FIG. 7B).

With continued reference to FIG. 6, at block 608, the processing system performs (e.g., using the pre-processing engine 514) pre-processing on results of the edge extraction. Pre-processing can include performing noise reduction, performing up-sampling on relative less dense areas (e.g., the area 713 of FIG. 7B as compared to the area 714), performing filtering to remove outliers, and/or the like, including combinations and/or multiples thereof. The representation 720 of FIG. 7C includes points 721 that represent the feature of interest subsequent to the pre-processing at block 608.

With continued reference to FIG. 6, at block 610, the processing system classifies (e.g., using the classification engine 515) the feature of interest based at least in part on results of the pre-processing. For example, the processing system classifies the object 701 based on one of a plurality of object classes. As shown in FIG. 7D, object classes 730 are shown. In this example, the object classes 730 include “circle,” “ellipse,” “round slot,” “rectangle,” and “cylinder.” The object classes 730 are merely examples, and other object classes may be used in other examples.

According to one or more embodiments, the processing system uses a trained machine learning model (e.g., a trained model 519) to classify the objects. Artificial intelligence, which includes machine learning is further described herein, including training (e.g., using the ML training engine 518) the machine learning model. In the example of FIGS. 7A-7E, the processing system classifies the points 721 (which represent the feature of interest (e.g., the feature 703)) as a “circle.” According to examples, each of the object classes 730 can include a likelihood or probability that the classification is correct. In FIG. 7D, the likelihood or probability (e.g., a score between 0 and 1, where 0 indicates no probability and 1 indicates a certainty) for each of the classes is represented by a horizontal scale, where a greater probability is indicated by a scale extended farther towards the right. Thus, in this example, the “circle” has a greatest likelihood or probability as compared to the “ellipse,” “round slot,” “rectangle,” and “cylinder” classes.

According to an example, the ML training engine 518, performs machine learning training to train the trained model 519. One example of a method for training the trained model 519 is as follows: generating a two-dimensional (2D) mask of primitives; applying a 2D data augmentation to the 2D mask of primitives to generate augmented images; and for each augmented image: identifying contours and applying a point-level transformation, and adding depth information based on the contours and the point-level transformation. Training the trained model 519 is further described herein with reference to FIG. 8 et seq.

With continued reference to FIG. 6, at block 612, the processing system constructs (e.g., using the fitting engine 516), based at least in part on results of the classifying, a geometric primitive or mathematical function that has a best fit to a set of points from the plurality of points associated with the feature of interest. According to one or more embodiments described herein, the fitting engine 516 uses a set of points and an expected geometric form as inputs to compute a geometric primitive. For example, for circles and ellipses, a least squares fitting approach can be used. FIG. 7C shows an example in which the points 721 that represent the feature of interest are extracted from the points for the edge 706. This representation is then fed into the classifier (e.g., using the classification engine 515) which outputs the category “circle” as the most probable class (730) for this example. Based on this classification, the circle best fit engine is then used on the points that represent the feature of interest which results in a circle primitive.

At block 614, the processing system generates (e.g., using the graphical representation engine 517) a graphical representation 740 of the feature of interest using the set of points. In the example of FIG. 7E, the feature of interest is represented by the circle 741, which represents the fitting output of the edge 706 of the feature of interest (e.g., the feature 703). The size of the hole (e.g., the feature of interest 703) can be verified using the circle 741, for example, such as by comparing a size of the circle 741 with a reference circle (e.g., a ground truth) for the feature 703. This provides for inspecting and verifying objects, such as the object 701.

It should be understood that the process depicted in FIG. 6 represents an illustration, and that other processes may be added or existing processes may be removed, modified, or rearranged without departing from the scope of the present disclosure.

One or more embodiments described herein can utilize machine learning techniques to perform tasks, such as classifying a feature of interest. More specifically, one or more embodiments described herein can incorporate and utilize rule-based decision making and artificial intelligence (AI) reasoning to accomplish the various operations described herein, namely classifying a feature of interest. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” and/or “trained machine learning model”) can be used for classifying a feature of interest, for example. In one or more embodiments, machine learning functionality can be implemented using an Artificial Neural Network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional Neural Networks (CNN) are a class of deep, feed-forward ANNs that are particularly useful at tasks such as, but not limited to analyzing visual imagery and natural language processing (NLP). Recurrent Neural Networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, the weights are adjusted via backpropagation that aims to reduce the error (defined by a loss function) between sample ground truth data and a predicted label on each iteration of learning (also known as epoch). As an example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of classifying a feature of interest as described herein (see, e.g., FIG. 6).

Systems for training and using a machine learning model are now described in more detail with reference to FIG. 8. Particularly, FIG. 8 depicts a block diagram of components of a machine learning training and inference system 800 according to one or more embodiments described herein. The system 800 performs training 802 and inference 804. During training 802, the ML training engine 518 trains a model (e.g., the trained model 519) to perform a task, such as to classifying a feature of interest. Inference 804 is the process of implementing the trained model 519 to perform the task, such as to classify a feature of interest, in the context of a larger system (e.g., a system 826). All or a portion of the system 800 shown in FIG. 8 can be implemented, for example by all or a subset of the processing system 500 OF FIG. 5.

The training 802 begins with training data 812, which may be structured or unstructured data. According to one or more embodiments described herein, the training data 812 includes original point cloud data and/or synthetic point cloud data. The ML training engine 518 receives the training data 812 and a model form 814. The model form 814 represents a base model that is untrained. The model form 814 can have preset weights and biases, which can be adjusted during training. It should be appreciated that the model form 814 can be selected from many different model forms depending on the task to be performed. For example, where the training 802 is to train a model to perform image classification, the model form 814 may be a model form of a CNN. The training 802 can be supervised learning, semi-supervised learning, unsupervised learning, reinforcement learning, and/or the like, including combinations and/or multiples thereof. For example, supervised learning can be used to train a machine learning model to classify an object of interest in an image. To do this, the training data 812 includes labeled images, including images of the object of interest with associated labels (ground truth) and other images that do not include the object of interest with associated labels. In this example, the ML training engine 518 takes as input a training image from the training data 812, makes a prediction for classifying the image, and compares the prediction to the known label. The ML training engine 518 then adjusts weights and/or biases of the model based on results of the comparison, such as by using backpropagation. The training 802 may be performed multiple times (referred to as “epochs”) until a suitable model is trained (e.g., the trained model 519).

Once trained, the trained model 519 can be used to perform inference 804 to perform a task, such as to classify a feature of interest. The inference engine 820 applies the trained model 519 to new data 822 (e.g., real-world, non-training data). For example, if the trained model 519 is trained to classify images of a particular object, such as a chair, the new data 822 can be an image of a chair that was not part of the training data 812. In this way, the new data 822 represents data to which the model trained has not been exposed. The inference engine 820 makes a prediction 824 (e.g., a classification of an object in an image of the new data 822) and passes the prediction 824 to the system 826 (e.g., the processing system 500 of FIG. 5). The system 826 can, based on the prediction 824, taken an action, perform an operation, perform an analysis, and/or the like, including combinations and/or multiples thereof. In some embodiments, the system 826 can add to and/or modify the new data 822 based on the prediction 824.

In accordance with one or more embodiments, the predictions 824 generated by the inference engine 820 are periodically monitored and verified to ensure that the inference engine 820 is operating as expected. Based on the verification, additional training 802 may occur using the trained model 519 as the starting point. The additional training 802 may include all or a subset of the original training data 812 and/or new training data 812. In accordance with one or more embodiments, the training 802 includes updating the trained model 519 to account for changes in expected input data.

Training machine learning models (e.g., the trained model 519) uses training data (e.g., the training data 812). In some cases, sufficient training data may not be available. Without sufficient training data, models cannot be trained to a desired level of accuracy, for example. For example, according to one or more embodiments described herein, a model trained with insufficient training data may not be able to correctly classify a feature of interest (e.g., a circle (see, e.g., FIG. 7A) may be incorrectly classified as another shape, such as an ellipse or round slot).

In an effort to cure this deficiency (e.g., lack of sufficient training data), one or more embodiments described herein provides for using synthetic training data for training a machine learning model that can be used for classifying features of interest. Synthetic data acts as a substitute for or supplement to real-world training data (referred to as “original” training data) and provides similar properties as the real-world training data. Thus, the synthetic data increases the amount of data available for training machine learning models. There are two primary types of synthetic training data: fully synthetic training data (e.g., no real-world data available) and partially synthetic training data (e.g., some real-world data available, and the synthetic data is aimed to be similar to this real-world data). One or more embodiments described herein generates point cloud primitives (e.g., cylinders, spheres, circles, rectangles, and/or the like, including combinations and/or multiples thereof) based on previously acquired and labeled real-world data (referred to as “original data”).

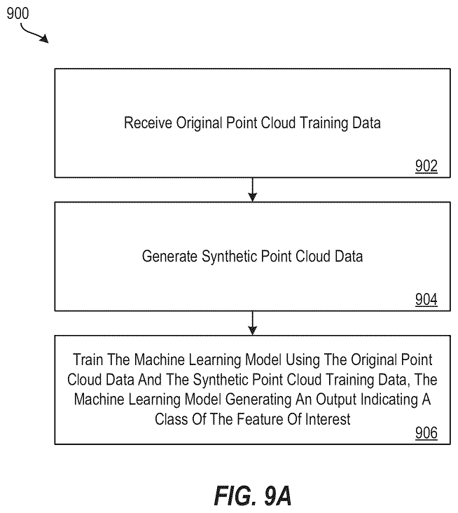

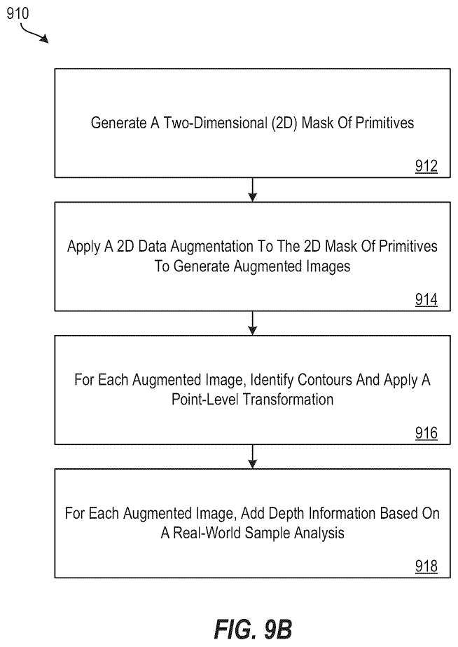

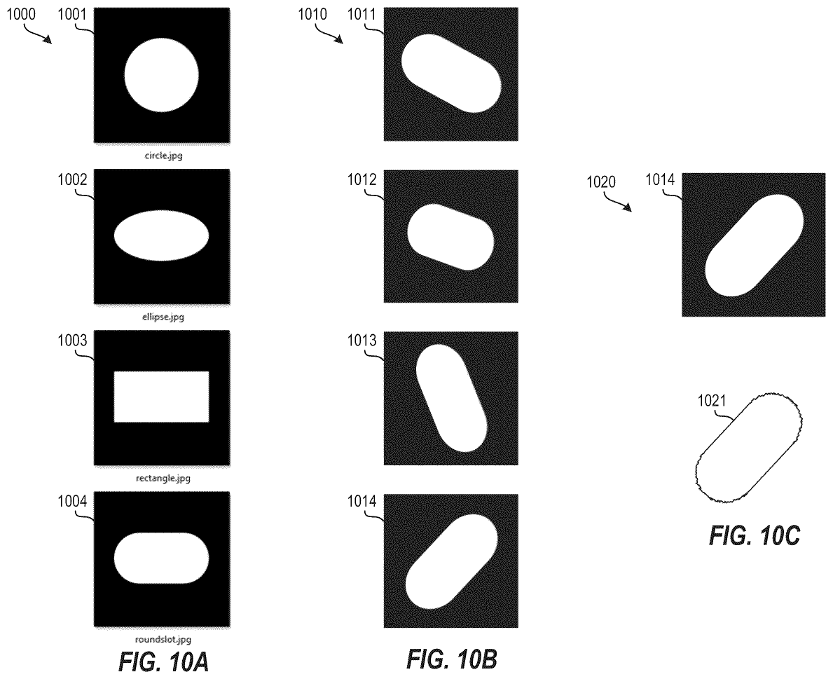

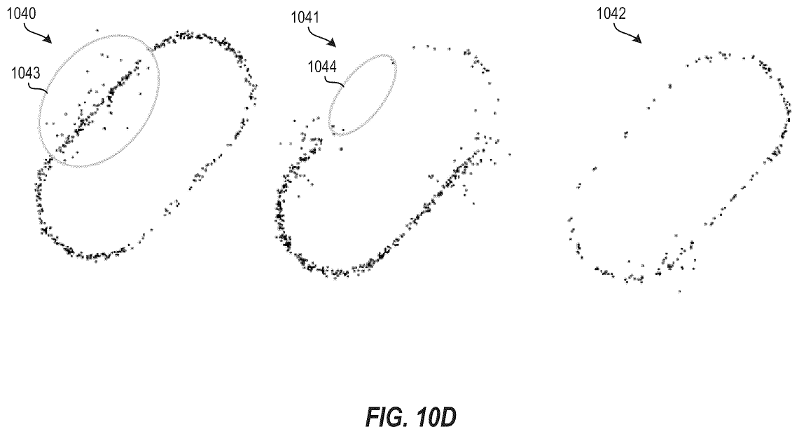

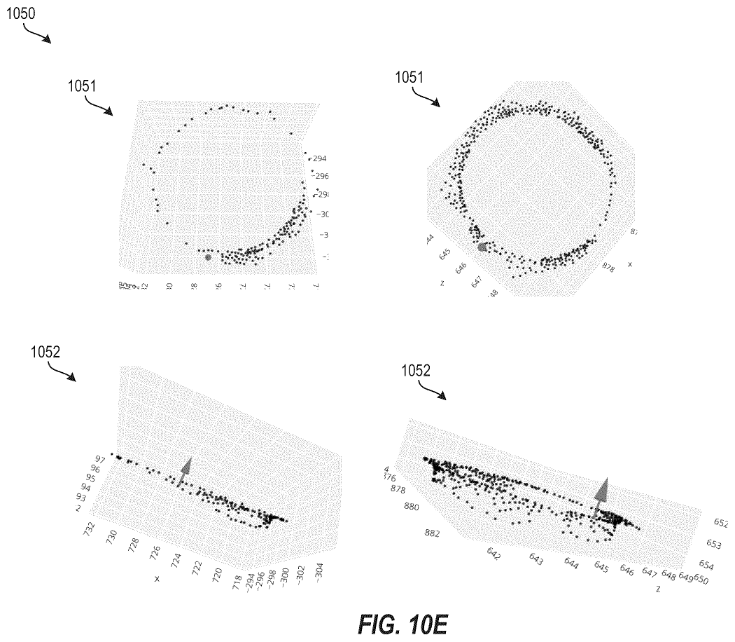

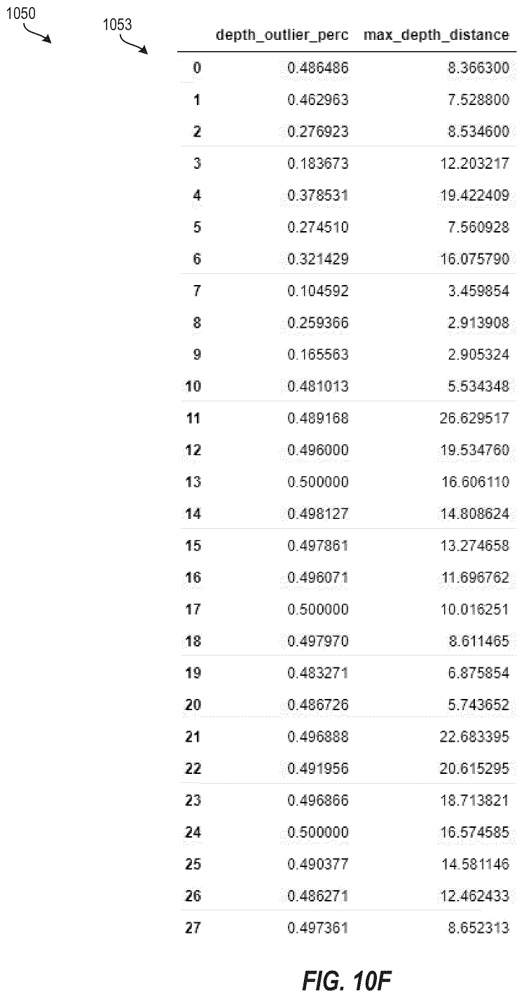

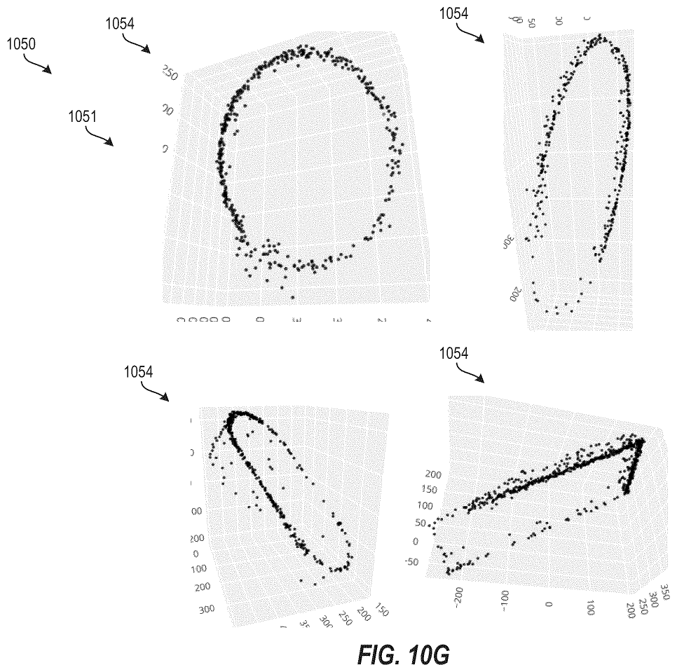

FIG. 9A is a flow diagram of a method 900 for training a machine learning model that can be used for classifying features of interest according to one or more embodiments described herein. FIG. 9B is a flow diagram of a method 910 for generating synthetic point cloud training data according to one or more embodiments described herein. The method 900 and/or the method 910 can be performed by any suitable system or device, such as the processing system 500 of FIG. 5, the machine learning training and inference system 800 of FIG. 8, and/or the processing system 1100 of FIG. 11. The methods 900, 910 are now described with further reference to FIGS. 10A-10D and 11.

At block 902, the processing system 500 receives original point cloud training data. Original point cloud training data is point cloud data collected by a 3D coordinate measurement device (e.g., the scanner 520) about a real-world object (e.g., the object 522). For example, the original point cloud training data represents a real-world feature of interest of a real-world object. The original point cloud training data can include point cloud data for multiple objects, multiple features of interest, and/or the like, including combinations and/or multiples thereof.

At block 904, the processing system 500 (e.g., using the ML training engine 518, another engine, any suitable processing system, and/or the like, including combinations and/or multiples thereof) generates synthetic point cloud training data. The synthetic point cloud training data is point cloud data that is simulated or generated to replace original point cloud training data but is not collected from a real-world object like the original point cloud training data. FIG. 9B depicts a method 910 for generating the synthetic point cloud training data and is now described in more detail with reference to FIGS. 10A-10D and 11. According to one or more embodiments described herein, synthetic data generation process is performed other than by the ML training engine 518 used for machine learning. According to one or more embodiments described herein, the machine learning model is trained using a processing system using a graphics processing unit (GPU) (e.g., to increase the training speed); however, the synthetic data can be generated by a system using a central processing unit (CPU) because generating the synthetic training data is less resource (e.g., processor load) intensive than training the machine learning model. It should be appreciated that any suitable system with a CPU (with or without a GPU) can be used to generate data according to one or more embodiments described herein.

With reference to FIG. 9B, at block 912, the processing system 500 (e.g., using the ML training engine 518, another engine, any suitable processing system, and/or the like, including combinations and/or multiples thereof) generates a two-dimensional (2D) mask of primitives. Primitives, or “geometric primitives,” are basic geometric shapes, such as a point, straight line segment, cure, circles, ellipses, and/or the like, including combinations and/or multiples thereof. FIG. 10A depicts a representation 1000 that shows masks 1001-1004 for different primitives. For example, the mask 1001 is a mask for a circle primitive, the mask 1002 is a mask for an ellipse primitive, the mask 1003 is a mask for a rectangle primitive, and the mask 1004 is a mask for a rounded slot primitive. Other primitives and 2D masks are also possible. According to one or more embodiments described herein, the 2D mask of primitives can be generated using a CPU and/or a GPU.

With continued reference to FIG. 9B, at block 914, the processing system 500 (e.g., using the ML training engine 518) applies a 2D data augmentation to the 2D mask of primitives to generate augmented images. The 2D data augmentation involves performing manipulations on the 2D masks of primitives. Examples of 2D data augmentation include, for example, distortion, scaling, rotation, and/or the like, including combinations and/or multiples thereof. FIG. 10B depicts a representation 1010 showing 2D data augmentation performed on the mask 1004 (e.g., a rounded slot primitive). Particularly, the representation 1010 includes augmented images 1011-1014 having different augmentations applied. For example, the augmented images 1011-1014 may be different augmentations applied to the mask 1004. As can be observed, each of the augmented images 1011-1014 are substantially round slots but have different transformations relative to the mask 1004.

With continued reference to FIG. 9B, at block 916, the processing system 500 (e.g., using the ML training engine 518), for each of the augmented images (e.g., each of the augmented images 1011-1014 of FIG. 10B), identifies contours. As shown in FIG. 10C, a representation 1020 includes a contours image 1021 that corresponds to the augmented image 1014. Contours of the augmented image 1014 are found to create the contours image 1021. In an embodiment, identifying the contours can be performed using a clockwise ordering of points. Also at block 916, the processing system 500 (e.g., using the ML training engine 518) applies a point-level transformation, which can be selected randomly. Examples of point-level transformations include dropout and gaussian noise. A dropout transformation removes a random set of points and can be applied in a random segment of the sorted points (dropout segment) and, within this segment, can randomly vary from 0, where no point is removed to 1, where all points in segment are removed (dropout ratio). A segment is a part of the point set and its length also can be tuned by a random parameter. If the length is 1, all point are used and the segment matches the whole set (general dropout). Similarly, the gaussian noise can be applied in all points (general noise) and/or a segment (segment noise). In either or both scenarios, the amount of noise (sigma value) is also defined in a parameter. The parameters used in these transformations can be defined manually or using statistics of real-world samples. For example, the amount of dropout ratio and/or the amount of noise defined by sigma value is defined by a previous noise analysis of real samples. One or more the transformations are applied to the sorted points set that resulted from contour extraction and/or the like, including combinations and/or multiples thereof. According to one or more embodiments described herein, a random generator can be used to provide for reproducible results. FIG. 10D shows representations 1040, 1041, 1042 that represent the process of applying the point-level transformation. For example, in the three samples, a general gaussian noise was applied. For the representations 1040 and 1041, the sigma value was higher than for the representation 1042. The segment 1043 of representation 1040 shows an example of noise applied locally in a segment. The amount of noise in that segment is higher than the general noise in the same representation 1040. Similarly, the segment 1044 of representation 1041 shows a dropout segment where almost all the points in that segment were removed (high dropout ratio within that segment). For the representation 1042, a general dropout was applied, which can be seen by the lack of general point density compared to the representations 1040 and 1041.

With continued reference to FIG. 9B, at block 918, the processing system 500 (e.g., using the ML training engine 518), for each of the output points of point-level transformations (e.g., each of the representation 1040-1042 of FIG. 10D), adds depth information by analyzing real data and associated real samples statistics (e.g., a real-world sample analysis) to determine depth outlier as a percentage and maximum depth distance. Using results of the analysis, the processing system 500 can infer the amount of depth to be added in previous transformed points. FIGS. 10E-10G together depict a method 1050 for adding depth information. Real data 1051 and associated real samples statistics 1052 can be analyzed to generate depth outlier as a percentage (“depth_outlier_perc”) and maximum depth distance (“max_depth_distance”) as shown in the table 1053. The processing system 500 can then use the information in the table 1053 to infer depth information for the previous transformed points (shown as images 1054 that include depth information).

With continued reference to FIG. 9A, at block 906, the processing system 500 (e.g., using the ML training engine 518) trains the machine learning model using the original point cloud data and the synthetic point cloud training data. Particularly, the machine learning model is trained to generate an output indicating a class of the feature of interest of the object.

It should be understood that the processes depicted in FIGS. 9A and 9B represents an illustration, and that other processes may be added or existing processes may be removed, modified, or rearranged without departing from the scope of the present disclosure.

FIGS. 11A-11D depict example synthetic point cloud training data according to one or more embodiments described herein. Particularly, FIG. 11A depicts examples of synthetic point cloud training data 1101-1106 for a circle, FIG. 11B depicts examples of synthetic point cloud training data 1111-1116 for an ellipse, FIG. 11C depicts examples of synthetic point cloud training data 1121-1126 for a rectangle, and FIG. 11D depicts examples of synthetic point cloud training data 1131-1136 for a round slot. These are merely examples of synthetic point cloud training data and should not be construed as limiting to the claims.

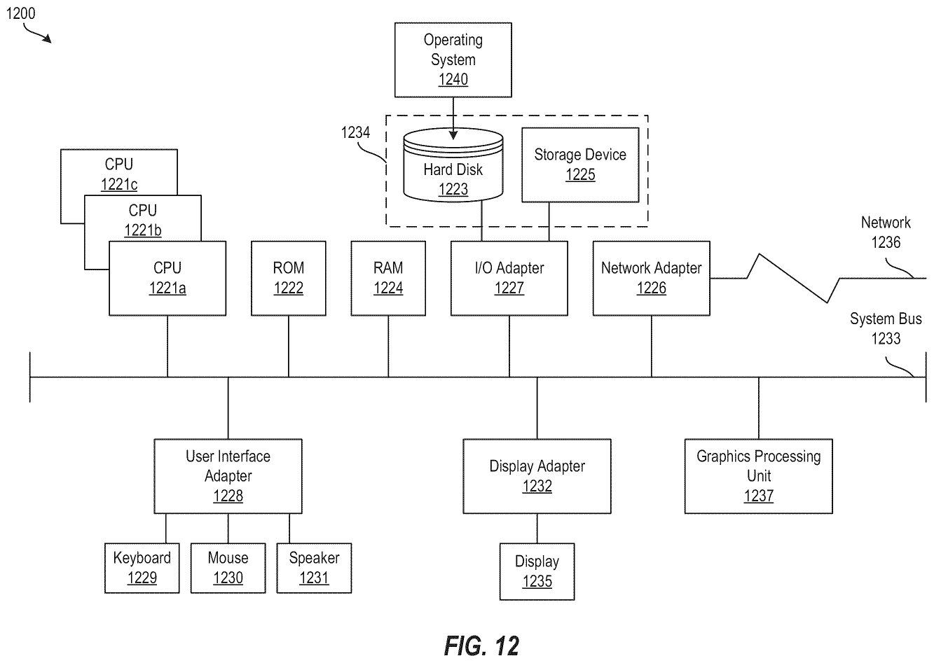

It is understood that one or more embodiments described herein is capable of being implemented in conjunction with any other type of computing environment now known or later developed. For example, FIG. 12 depicts a block diagram of a processing system 1200 for implementing the techniques described herein. In accordance with one or more embodiments described herein, the processing system 1200 is an example of a cloud computing node of a cloud computing environment. In examples, processing system 1200 has one or more central processing units (“processors” or “processing resources” or “processing devices”) 1221a, 1221b, 1221c, etc. (collectively or generically referred to as processor(s) 1221 and/or as processing device(s)). In aspects of the present disclosure, each processor 1221 can include a reduced instruction set computer (RISC) microprocessor. Processors 1221 are coupled to system memory (e.g., random access memory (RAM) 1224) and various other components via a system bus 1233. Read only memory (ROM) 1222 is coupled to system bus 1233 and may include a basic input/output system (BIOS), which controls certain basic functions of processing system 1200.

Further depicted are an input/output (I/O) adapter 1227 and a network adapter 1226 coupled to system bus 1233. I/O adapter 1227 may be a small computer system interface (SCSI) adapter that communicates with a hard disk 1223 and/or a storage device 1225 or any other similar component. I/O adapter 1227, hard disk 1223, and storage device 1225 are collectively referred to herein as mass storage 1234. Operating system 1240 for execution on processing system 1200 may be stored in mass storage 1234. The network adapter 1226 interconnects system bus 1233 with an outside network 1236 enabling processing system 1200 to communicate with other such systems.

A display (e.g., a display monitor) 1235 is connected to system bus 1233 by display adapter 1232, which may include a graphics adapter to improve the performance of graphics intensive applications and a video controller. In one aspect of the present disclosure, adapters 1226, 1227, and/or 1232 may be connected to one or more I/O busses that are connected to system bus 1233 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 1233 via user interface adapter 1228 and display adapter 1232. A keyboard 1229, mouse 1230, and speaker 1231 may be interconnected to system bus 1233 via user interface adapter 1228, which may include, for example, a Super I/O chip integrating multiple device adapters into a single integrated circuit.

In some aspects of the present disclosure, processing system 1200 includes a graphics processing unit 1237. Graphics processing unit 1237 is a specialized electronic circuit designed to manipulate and alter memory to accelerate the creation of images in a frame buffer intended for output to a display. In general, graphics processing unit 1237 is very efficient at manipulating computer graphics and image processing, and has a highly parallel structure that makes it more effective than general-purpose CPUs for algorithms where processing of large blocks of data is done in parallel.

Thus, as configured herein, processing system 1200 includes processing capability in the form of processors 1221, storage capability including system memory (e.g., RAM 1224), and mass storage 1234, input means such as keyboard 1229 and mouse 1230, and output capability including speaker 1231 and display 1235. In some aspects of the present disclosure, a portion of system memory (e.g., RAM 1224) and mass storage 1234 collectively store the operating system 1240 to coordinate the functions of the various components shown in processing system 1200.

It will be appreciated that one or more embodiments described herein may be embodied as a system, method, or computer program product and may take the form of a hardware embodiment, a software embodiment (including firmware, resident software, micro-code, etc.), or a combination thereof. Furthermore, one or more embodiments described herein may take the form of a computer program product embodied in one or more computer readable medium(s) having computer readable program code embodied thereon.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A method for feature extraction, the method comprising:
receiving a selection of a point from a plurality of points, the plurality of points representing an object;
identifying a feature of interest for the object based at least in part on the point;
performing edge extraction on the feature of interest;
performing pre-processing on results of the edge extraction;
classifying the feature of interest based at least in part on results of the pre-processing;
constructing, based at least in part on results of the classifying, a geometric primitive or mathematical function that has a best fit to a set of points from the plurality of points associated with the feature of interest; and
generating a graphical representation of the feature of interest using the geometric primitive or mathematical function.

2. The method of claim 1, wherein the plurality of points form a point cloud, wherein the point cloud is based on data captured by a three-dimensional (3D) coordinate measurement device.

3. The method of claim 2, wherein the 3D coordinate measurement device is a laser scanner.

4. The method of claim 1, wherein performing the edge extraction is performed using tensor voting.

5. The method of claim 1, wherein performing the edge extraction comprises:
determining a normal of points from the plurality of points associated with the feature of interest;
constructing a matrix using the normal;
calculating eigen values for the matrix;
identifying sharp edge vertices based on the eigen values; and
clustering the sharp edge vertices.

6. The method of claim 1, wherein performing the pre-processing comprises performing at least one pre-process selected from a group consisting of performing noise reduction on the results of the edge extraction, performing up-sampling on relative less dense areas of the results of the edge extraction, and performing filtering to remove outliers from the results of the edge extraction.

7. The method of claim 1, wherein the classifying is performed using a machine learning model.

8. The method of claim 7, further comprising training the machine learning model.

9. The method of claim 8, wherein training the machine learning model comprises:
generating a two-dimensional (2D) mask of primitives;
applying a 2D data augmentation to the 2D mask of primitives to generate augmented images; and
for each augmented image:
identifying contours and applying a point-level transformation, and
adding depth information based on the contours and the point-level transformation.

10. A system for feature extraction, the system comprising:
a three-dimensional (3D) coordinate measurement device to collect a plurality of points representing an object; and
a processing system comprising:
a memory comprising computer readable instructions; and
a processing device for executing the computer readable instructions, the computer readable instructions controlling the processing device to perform operations comprising:
receiving a selection of a point from the plurality of points;
identifying a feature of interest for the object based at least in part on the point;
performing edge extraction on the feature of interest; and
classifying the feature of interest based at least in part on results of the edge extraction.

11. The system of claim 10, wherein the plurality of points form a point cloud.

12. The system of claim 11, wherein the 3D coordinate measurement device is a laser scanner.

13. The system of claim 10, wherein performing the edge extraction is performed using tensor voting.

14. The system of claim 10, wherein performing the edge extraction comprises:
determining a normal of points from the plurality of points associated with the feature of interest;
constructing a matrix using the normal;
calculating eigen values for the matrix;
identifying sharp edge vertices based on the eigen values; and
clustering the sharp edge vertices.

15. The system of claim 10, wherein the operations further comprise performing pre-processing on results of the edge extraction.

16. The system of claim 15, wherein performing the pre-processing comprises performing at least one pre-process selected from a group consisting of performing noise reduction on the results of the edge extraction, performing up-sampling on relative less dense areas of the results of the edge extraction, and performing filtering to remove outliers from the results of the edge extraction.

17. The system of claim 10, wherein the classifying is performed using a machine learning model.

18. The system of claim 17, wherein the operations further comprise training the machine learning model.

19. The system of claim 10, wherein the operations further comprise extracting, based at least in part on results of the classifying, a set of points from the plurality of points associated with the feature of interest.

20. The system of claim 10, wherein the operations further comprise generating a graphical representation of the feature of interest based at least in part on classifying the feature of interest.

21. The system of claim 10, wherein the 3D coordinate measurement device is a laser scanner.
